(19) United States
(12) Patent Application Publication
(10) Pub. No.: US 2009/0010032 A1
(43) Pub. Date: Jan. 8, 2009

(54) Power supply capable of reducing secondary-side noise

(75) Inventors: Weber Chuang, Hsinshu (TW); Charles Huang, Keelung (TW); Jack Lee, Taipei County (TW); Jenn-Jong Shieh, Hsinchu County (TW)

Correspondence Address: Weber Chuang, P.O. Box 44-2049, Taipei, 10668, TW

(73) Assignee: Jentec Technology Co., Ltd.

(21) Appl. No.: 12/155,854

(22) Filed: Jun. 11, 2008

(30) Foreign Application Priority Data
Jul. 6, 2007 (TW) 096124598

(51) Int. Cl. H02M 7/06

(52) U.S. Cl. 363/126

(57) ABSTRACT

A switching power supply capable of reducing secondary-side noise mainly has at least one decoupling device for guiding the secondary-side noise to at least a terminal of an AC power supply. Thus, the secondary-side high-frequency noise can be reduced, and the quality in using the electronic apparatus product, which is electrically connected to the output of the switching AC-to-DC power supply, can be greatly enhanced.

### BACKGROUND OF THE INVENTION

(1) Field of the Invention

The invention relates to a power supply, and more particularly to a switching AC-to-DC power supply capable of reducing secondary-side noise.

(2) Description of the Prior Art

An electronic device is usually powered by a battery so that it can be easily and conveniently carried. However, the storage capacity of the battery limits the time of using the electronic device. Although the efficiency of the battery is enhanced and improved again and again, the limited time of using the electronic device always exists.

When the electronic device is continuously used for a very long period of time, the battery may be integrated with an AC-to-DC power supply in order to solve the problems of charging the battery and the limited storage capacity. The most economic way for implementing the AC-to-DC power supply is to use a linear transformer. Although the linear transformer can solve the problem of time for continuously using the electronic device, the operation frequency of the linear transformer is very low. So, the linear transformer has the large size and the heavy weight relative to the switching AC-to-DC power supply, and the poor efficiency of the linear transformer can't be accepted by the user. Although the linear transformer has the cheaper price, it will be finally replaced by the switching AC-to-DC power supply under the condition of the high performance and the trends of the miniaturized size and the power saving property.

The switching AC-to-DC power supplies may be divided into a non-constant frequency self-excited oscillation (e.g. RCC) power supply and a constant frequency pulse width modulation (PWM) power supply according to the corresponding operation frequency characteristic. FIG. 1 is block diagram showing a conventional switching AC-to-DC power supply. Referring to FIG. 1, an input AC voltage AC INPUT is transformed into a DC voltage Vdc by an input filter device 101, a rectifier 102 and a filter capacitor 103. A switching DC-to-DC power supply 10 transforms the DC voltage Vdc into a predetermined output voltage Vo. A load (not shown) including, without limitation to, an analog signal amplifier, a digital signal amplifier, a medical equipment apparatus, a router, a Voice Over Internet Protocol (VOIP) or an IAD, may be powered by the output voltage Vo. The switching DC-to-DC power supply 10 may be any type of DC power supply including, without limitation to, a DC power supply which comprises at least a Buck, Boost, Flyback, Forward and Class D type. For the sake of illustrating the effects of the invention, the switching DC-to-DC power supply 10 of the invention is illustrated by taking the Flyback type DC power supply as an example. When the input voltage is in a positive half cycle, the current flows through the input filter device 101 so that the rectifier 102 charges the filter capacitor 103, and then the current flows back to the power supply through the ground of the filter capacitor 103. The voltage of the filter capacitor 103 encounters high-frequency switching operations of turning on and off a switch 108, and is transformed by a transformer 104 according to a voltage ratio and then rectified and filtered by a diode 106 and a capacitor 107 to generate an output voltage serving as the DC voltage Vo. When the input voltage is in a negative half cycle, the current flows through the input filter device 101 so that the rectifier 102 charges the filter capacitor 103, and then the current flows back to the power supply through the filter capacitor 103. The voltage of the filter capacitor 103 encounters the high-frequency switching operations of turning on and off the switch 108, and is transformed by the transformer 104 according to the voltage ratio and then rectified and filtered by the diode 106 and the capacitor 107 to generate the output voltage serving as the DC voltage Vo. The circuit is continuously and stably operated according to this above-mentioned rule. A pulse width modulation (PWM) controller 109 receives at least a signal, which is generated by a feedback circuit 110 according to the DC voltage Vo, to control the switch 108 to turn on and off at high frequency.

However, the size of the switching power supply is usually very small when the operation frequency thereof is getting higher and higher, and the efficiency thereof is very high so that the power saving trend is quite satisfied. However, its drawback is that the high-frequency noise is contained in the output voltage, especially in a switching PWM power supply, when the operation frequency is getting higher and higher. At present, the high-frequency noise of the output voltage of the power supply is not specified by any rules and is acceptable as long as the system can be operated in a worriless manner. However, when an electronic product (i.e., the load of the power supply) is powered by the output voltage of a power supply, the electronic product has to satisfy the noise leakage from the power supply to the input power system of the product according to the rules of the electromagnetic compatibility (EMC) and the electromagnetic interference (EMI) in order to prevent the product from being influenced by the high-frequency noise of the power supply. Therefore, if the high-frequency noise of the output voltage of the switching power supply is not controlled, some products, which are very sensitive to the power system noise, may encounter the following problems when using the switching power supply.

First, when the signal of the system product is very small, the high-frequency noise of the power supply disables the system product, such as a sounder system, from operation normally.

Second, the system product preferably has the higher communication rate and the wider bandwidth. Correspondingly, the high noise of the power supply decreases the communication rate and the bandwidth.

The circuit architecture for reducing the secondary-side noise of the switching power supply may include the RCC power supply or the 3-pin desktop architecture with the power line and the ground line. However, the RCC power supply operates according to natural oscillation, its operating frequency is determined by the element parameters of the RCC power supply, and the practical production cannot be easily controlled. So, the customer does not adopt this type of power supply in some system applications. As for the 3-pin desktop power supply, the 3-pin plugs are not used all over the world. Even if the power system has the power line and the ground line, this function is disabled when the user does not connect the ground line or the ground line pin of the power line plug is removed.

It is to be noted that the secondary-side high-frequency noise of the switching power supply can be theoretically reduced using a multi-stage filter. However, the high-current secondary-side multi-stage filter to be implemented in an electronic apparatus product with the competition ability is very challenging or even cannot be implemented under the real considerations of the cost and the space.

Thus, the invention discloses a switching AC-to-DC power supply capable of reducing the secondary-side noise. The power supply mainly uses at least one decoupling device to guide the secondary-side high-frequency noise to at least one terminal of the AC power supply. Thus, the secondary-side high-frequency noise can be reduced, and the quality in using the electronic apparatus product, which is electrically connected to the output of the switching AC-to-DC power supply, can be greatly enhanced.

### SUMMARY OF THE INVENTION

In a first embodiment, the invention provides a switching AC-to-DC power supply capable of reducing secondary-side noise. The power supply includes an AC power input port, a rectifier, an input filter device, a filter capacitor, a switching DC-to-DC power supply and a first decoupling device. The switching DC-to-DC power supply includes at least one switch element, transforms a voltage of the filter capacitor into a DC voltage and outputs the DC voltage from an output port. The output port includes a first DC power output terminal and a second DC power output terminal. The AC power input port is electrically connected to input terminals of the rectifier. First and second output terminals of the rectifier are electrically connected to the input terminals of the input filter device in parallel. The output terminals of the input filter device are electrically connected to the filter capacitor and the input terminals of the switching DC-to-DC power supply in parallel. The first decoupling device is electrically connected to the first DC power output terminal and the first or second output terminal of the rectifier.

In a second embodiment, a switching AC-to-DC power supply capable of reducing secondary-side noise includes an AC power input port, a rectifier, an input filter device, a filter capacitor, a switching DC-to-DC power supply and a first decoupling device. The switching DC-to-DC power supply includes at least one switch element, transforms a voltage of the filter capacitor into a DC voltage and outputs the DC voltage from an output port. The output port includes a first DC power output terminal and a second DC power output terminal. The AC power input port is electrically connected to input terminals of the rectifier. First and second output terminals of the rectifier are electrically connected to input terminals of the input filter device. Output terminals of the input filter device are electrically connected to the filter capacitor and input terminals of the switching DC-to-DC power supply in parallel. The first decoupling device is electrically connected to the second DC power output terminal and the first output terminal or the second output terminal of the rectifier.

In a third embodiment, a switching AC-to-DC power supply capable of reducing secondary-side noise includes an AC power input port, a rectifier, an input filter device, a filter capacitor, a switching DC-to-DC power supply, a first decoupling device and a second decoupling device. The switching DC-to-DC power supply includes at least one switch element, and transforms a voltage of the filter capacitor into a DC voltage at an output port. The output port includes a first DC power output terminal and a second DC power output terminal. The AC power input port is electrically connected to input terminals of the rectifier. First and second output terminals of the rectifier are electrically connected to input terminals of the input filter device in parallel. Output terminals of the input filter device are electrically connected to the filter capacitor and input terminals of the switching DC-to-DC power supply in parallel. The first decoupling device is electrically connected to the first DC power output terminal and the first output terminal of the rectifier. The second decoupling device is electrically connected to the first DC power output terminal and the second output terminal of the rectifier. Alternatively, the second decoupling device is electrically connected to the second DC power output terminal and the first or second output terminal (not shown) of the rectifier.

In a fourth embodiment, a switching AC-to-DC power supply capable of reducing secondary-side noise includes an AC power input port, a rectifier, an input filter device, a filter capacitor, a switching DC-to-DC power supply, a first decoupling device and a second decoupling device. The switching DC-to-DC power supply includes at least one switch element, transforms a voltage of the filter capacitor into a DC voltage and outputs the DC voltage from an output port. The output port includes a first DC power output terminal and a second DC power output terminal. The AC power input port is electrically connected to input terminals of the rectifier. First and second output terminals of the rectifier are electrically connected to input terminals of the input filter device. Output terminals of the input filter device are electrically connected to the filter capacitor and input terminals of the switching DC-to-DC power supply in parallel. The first decoupling device is electrically connected to the second DC power output terminal and the first output terminal of the rectifier. The second decoupling device is electrically connected to the second DC power output terminal and the second output terminal of the rectifier. Alternatively, the first decoupling device is electrically connected to the first DC power output terminal and the second output terminal (not shown) of the rectifier. Alternatively, the first decoupling device is electrically connected to the first DC power output terminal and the second output terminal of the rectifier, and the second decoupling device is electrically connected to the second DC power output terminal and the first output terminal (not shown) of the rectifier.

The present invention will be apparent from the following detailed description, which proceeds with reference to the accompanying drawings, wherein the same references relate to the same elements.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is block diagram showing a conventional switching AC-to-DC power supply.

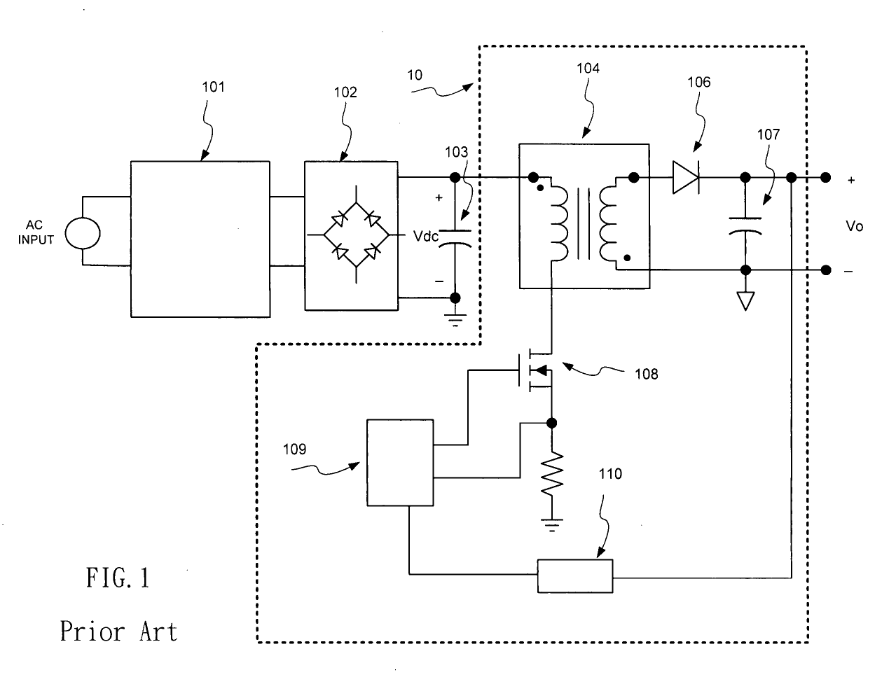

FIG. 2 shows a power supply according to a first embodiment of the invention.

FIG. 3 shows a power supply according to a second embodiment of the invention.

FIG. 4 shows a power supply according to a third embodiment of the invention.

FIG. 5 shows a power supply according to a fourth embodiment of the invention.

FIG. 6 shows an experimental waveform of high-frequency noise at an output voltage port Vo of the conventional switching AC-to-DC power supply.

FIG. 7 shows an experimental waveform of high-frequency noise at the output voltage port Vo of the power supply according to the invention.

### DETAILED DESCRIPTION OF THE PREFERRED EMBODIMENTS

Reference will now be made in detail to embodiments of the present invention. While the invention will be described in conjunction with the embodiments, it will be understood that they are not intended to limit the invention to these embodiments. On the contrary, the invention is intended to cover alternatives, modifications and equivalents, which may be included within the spirit and scope of the invention as defined by the appended claims.

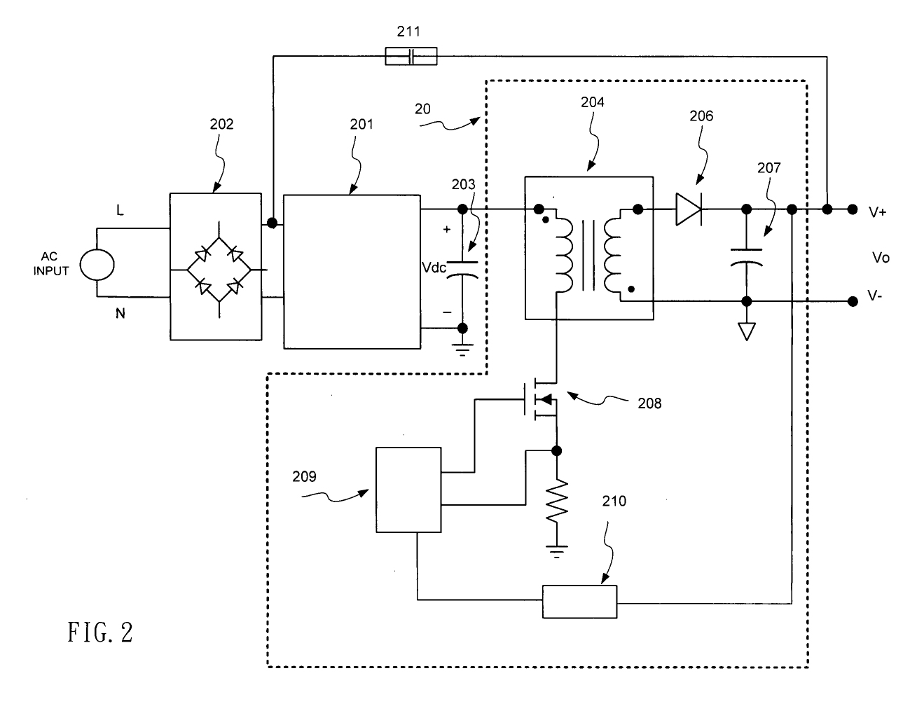

FIG. 2 shows a power supply according to a first embodiment of the invention. Referring to FIG. 2, the power supply includes an AC power input port AC INPUT, a rectifier 202, an input filter device 201, a filter capacitor 203, a switching DC-to-DC power supply 20 and a first decoupling device 211. The AC power input port has an L terminal and an N terminal. The rectifier 202 may be, without limitation to, any full-wave rectifier or half-wave rectifier. The switching DC-to-DC power supply 20 may be any type of DC power supply including, without limitation to, a DC power supply composed of Buck, Boost, Flyback, Forward and/or Class D type. The DC-to-DC power supply 20 transforms the voltage of the filter capacitor into a DC output voltage, and outputs the DC output voltage from an output port Vo. The output port includes a first DC power output terminal V+ and a second DC power output terminal V−. The AC power input port AC INPUT is electrically connected to input terminals of the rectifier 202. First and second output terminals of the rectifier 202 are electrically connected to the input filter device 201 in parallel, and are electrically connected to input terminals of the filter capacitor 203. The filter capacitor 203 is electrically connected to input terminals of the switching DC-to-DC power supply 20 in parallel. The first decoupling device 211 includes, without limitation to, a capacitor element. The first decoupling device 211 is electrically connected to the first DC power output terminal V+ and the first output terminal of the rectifier 202. With regard to the high-frequency noise generated at the secondary side output port, a low-impedance path, which starts from the first DC power output terminal V+ to the first decoupling device 211, the first output terminal of the rectifier 202 and the ground of the input filter device 201 and ends at the second DC power output terminal V−, is formed to guide the high-frequency noise generated by the secondary side output port to the input filter device 201. Therefore, the high-frequency noise generated at the secondary side output port can be greatly reduced. The high-frequency noise generated at the primary side of the power supply of the invention is filtered out by the input filter device 201 to prevent the noise from injecting back into the AC power input port AC INPUT. Similarly, the first decoupling device 211 is electrically connected to the first DC power output terminal V+ and the second output terminal of the rectifier 202, and also has the same effects (not shown).

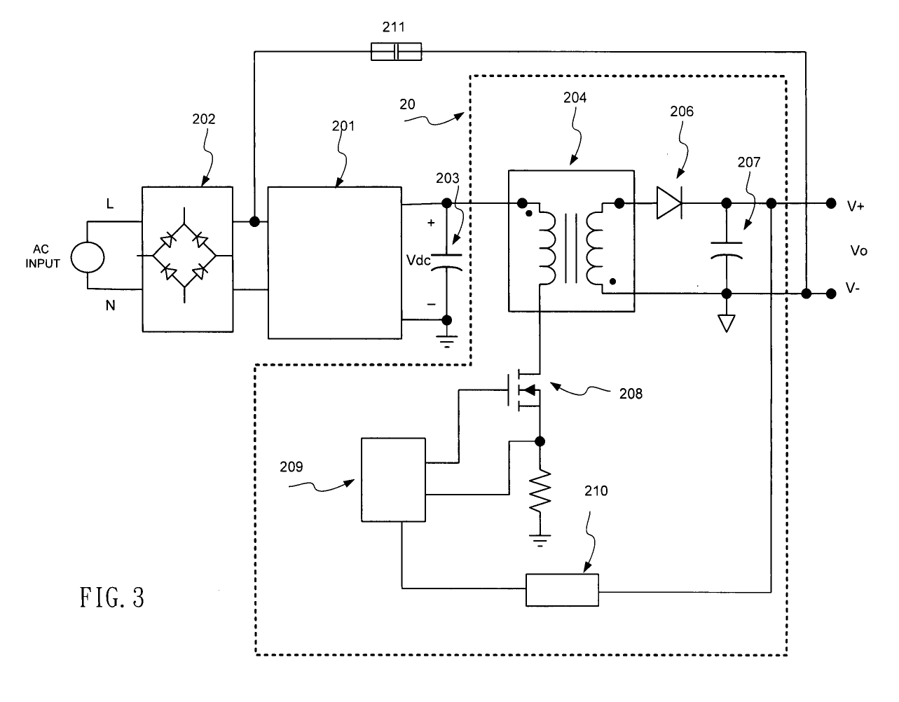

FIG. 3 shows a power supply according to a second embodiment of the invention. Similar to FIG. 2, the first decoupling device 211 of FIG. 3 is electrically connected to the second DC power output terminal V− and the first output terminal of the rectifier 202 or the second output terminal (not shown) of the rectifier 202 so that the same effects may be obtained.

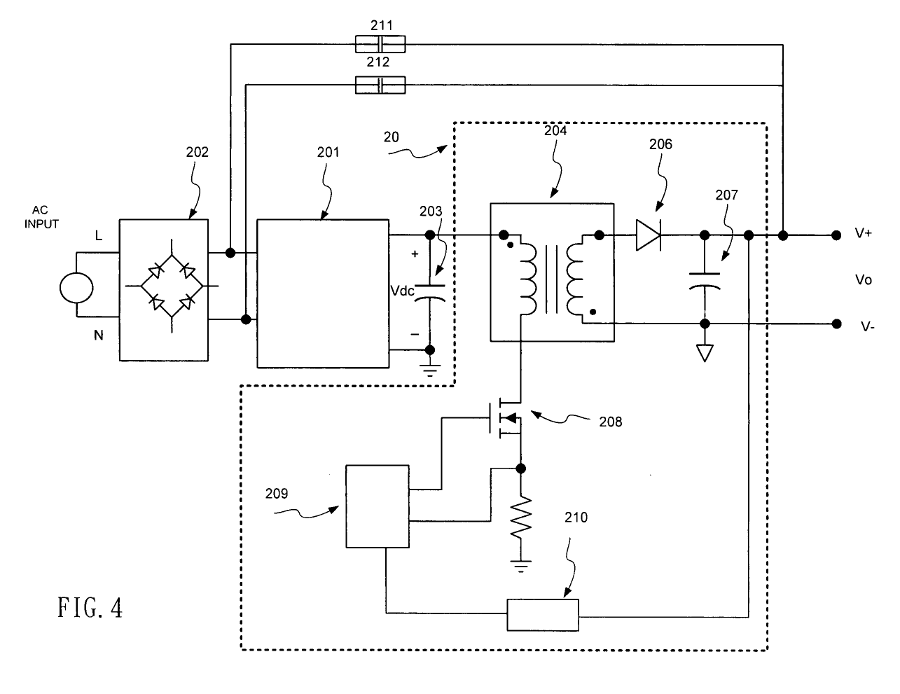

FIG. 4 shows a power supply according to a third embodiment of the invention. Referring to FIG. 4, the power supply according to the third embodiment of the invention includes an AC power input port AC INPUT, a rectifier 202, an input filter device 201, a filter capacitor 203, a switching DC-to-DC power supply 20, a first decoupling device 211 and a second decoupling device 212. The AC power input port has an L terminal and an N terminal. The rectifier 202 may be, without limitation to, any full-wave rectifier or half-wave rectifier. The switching DC-to-DC power supply 20 may be any type of DC power supply including, without limitation to, a DC power supply composed of Buck, Boost, Flyback, Forward and/or Class D type. The DC-to-DC power supply 20 transforms the voltage of the filter capacitor into a DC output voltage at an output port Vo. The output port includes a first DC power output terminal V+ and a second DC power output terminal V−. The AC power input port AC INPUT is electrically connected to input terminals of the rectifier 202. First and second output terminals of the rectifier 202 are electrically connected to input terminals of the input filter device 201. Output terminals of the input filter device 201 are electrically connected to the filter capacitor 203 and input terminals of the switching DC-to-DC power supply 20 in parallel. The first decoupling device 211 includes, without limitation to, a capacitor element. The first decoupling device 211 is electrically connected to the first DC power output terminal V+ and the first output terminal of the rectifier 202. The second decoupling device 212 includes, without limitation to, a capacitor element. The second decoupling device 212 is electrically connected to the first DC power output terminal V+ and the second output terminal of the rectifier 202. As mentioned hereinabove, a low-impedance path is formed due to the additions of the first decoupling device 211 and the second decoupling device so that the high-frequency noise generated at the secondary side output port can be guided to the input filter device 201.

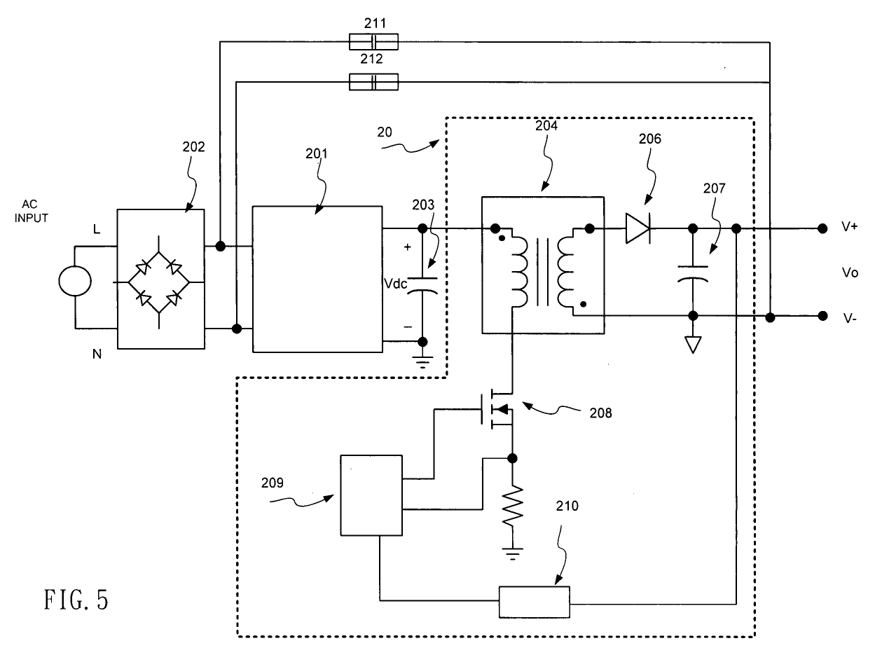

FIG. 5 shows a power supply according to a fourth embodiment of the invention. Similar to FIG. 4, the first decoupling device 211 of FIG. 4 is electrically connected to the second DC power output terminal V− and the first output terminal of the rectifier 202, and the second decoupling device 212 is electrically connected to the second DC power output terminal V− and the second output terminal of the rectifier 202 so that the same effects may also be obtained.

Similarly, the first decoupling device 211 may be electrically connected to the first DC power output terminal V+ and the first output terminal of the rectifier 202, and the second decoupling device 212 may be electrically connected to the second DC power output terminal V− and the first output terminal of the rectifier 202. The first decoupling device 211 may be electrically connected to the first DC power output terminal V+ and the first output terminal of the rectifier 202. The second decoupling device 212 may be electrically connected to the second DC power output terminal V− and the second output terminal of the rectifier 202. The first decoupling device 211 may be electrically connected to the first DC power output terminal V+ and the second output terminal of the rectifier 202. The second decoupling device 212 may be electrically connected to the second DC power output terminal V− and the first output terminal of the rectifier 202. The first decoupling device 211 may be electrically connected to the first DC power output terminal V+ and the second output terminal of the rectifier 202. The second decoupling device 212 may be electrically connected to the second DC power output terminal V− and the second output terminal of the rectifier 202. Thus, the same effects may also be obtained.

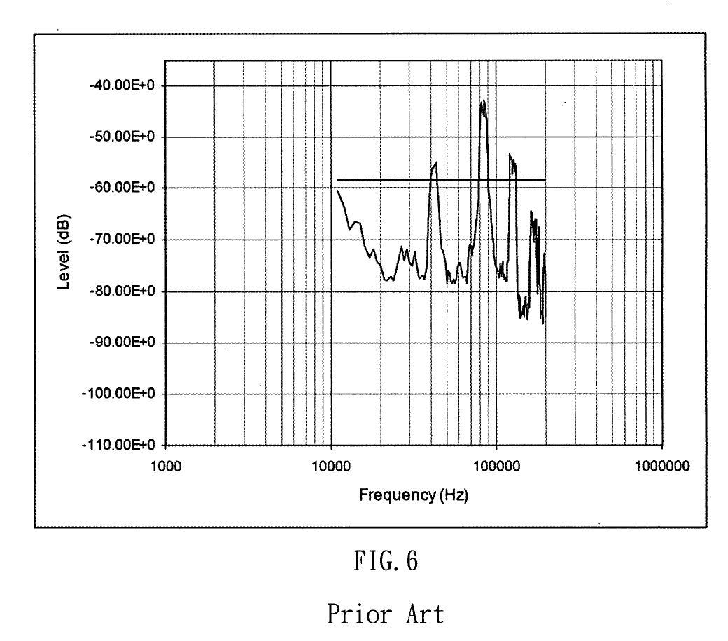

FIG. 6 shows an experimental waveform of high-frequency noise at an output voltage port Vo of the conventional switching AC-to-DC power supply. As shown in FIG. 6, it is obtained that the high-frequency noise at the secondary side output voltage port Vo of the conventional switching AC-to-DC power supply is obviously higher than an expected value of −58 dB in some frequency zones.

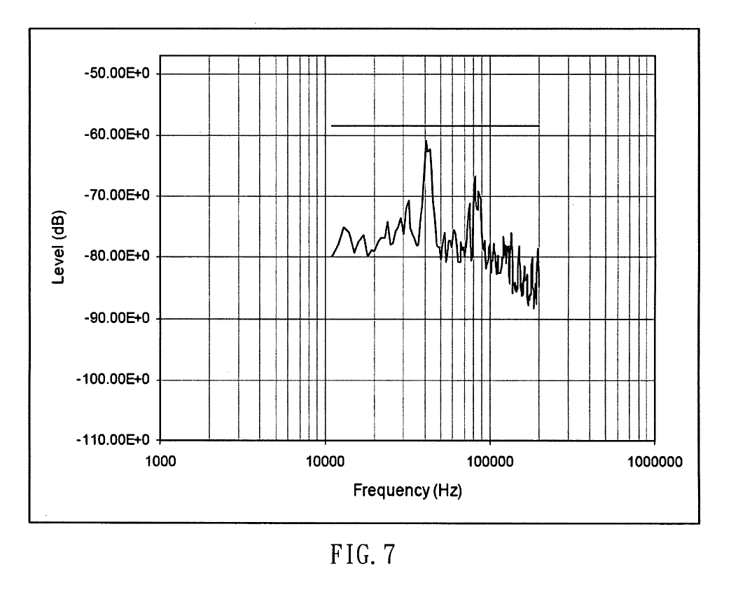

FIG. 7 shows an experimental waveform of high-frequency noise at the output voltage port Vo of the power supply according to the invention, wherein the specification of the switching AC-to-DC power supply is the same as that of FIG. 6. As shown in FIG. 7, the high-frequency noise at the secondary side output voltage port Vo of the power supply of the invention is lower than the expected value of −58 dB at any frequency.

In summary, the invention has the following advantages.

First, the power supply of the invention provides a low-impedance path for the high-frequency noise at the secondary side of the switching power supply so that the noise can be guided to the AC input power supply.

Second, the power supply of the invention can provide a low-cost and effective filter function.

Third, the power supply of the invention can further greatly enhance the communication bandwidth and the communication quality due to the reduction of the output voltage noise of the power supply when the load of the output port is a telephone or a Voice Over Internet Protocol (VOIP) phone.

While the foregoing description and drawings represent embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. A switching AC-to-DC power supply capable of reducing secondary-side noise, the switching AC-to-DC power supply comprising a rectifier, an input filter device, a switching DC-to-DC power supply and a first decoupling device, wherein:
the rectifier has input terminals electrically connected to an AC power, and a first and second output terminals electrically connected to the input filter device;
the input filter device has input terminals electrically connected to the output terminals of the rectifier, and output terminals electrically connected to a filter capacitor in parallel and electrically connected to input terminals of the switching DC-to-DC power supply;
the switching DC-to-DC power supply comprises at least one switch element, transforms a voltage of the filter capacitor into a DC voltage, and outputs the DC voltage from a first and second DC power output terminals; and
the first decoupling device has a first terminal electrically connected to the first DC power output terminal, and a second terminal electrically connected to the first output terminal of the rectifier.

2. The power supply according to claim 1, wherein the first decoupling device is electrically connected to the first DC power output terminal and the second output terminal of the rectifier.

3. The power supply according to claim 1, wherein the first decoupling device is electrically connected to the second DC power output terminal and the first output terminal of the rectifier.

4. The power supply according to claim 1, wherein the first decoupling device is electrically connected to the second DC power output terminal and the second output terminal of the rectifier.

5. The power supply according to claim 1, further comprising a second decoupling device electrically connected to the first DC power output terminal and the second output terminal of the rectifier.

6. The power supply according to claim 3, further comprising a second decoupling device, which is electrically connected to the second DC power output terminal and the second output terminal of the rectifier.

7. The power supply according to claim 1, further comprising a second decoupling device, which is electrically connected to the second DC power output terminal and the first output terminal of the rectifier.

8. The power supply according to claim 1, further comprising a second decoupling device, which is electrically connected to the second DC power output terminal and the second output terminal of the rectifier.

9. The power supply according to claim 2, further comprising a second decoupling device, which is electrically connected to the second DC power output terminal and the first output terminal of the rectifier.

10. The power supply according to claim 2, further comprising a second decoupling device, which is electrically connected to the second DC power output terminal and the second output terminal of the rectifier.

11. The power supply according to claim 1, wherein the rectifier is a full-wave rectifier or a half-wave rectifier.

12. The power supply according to claim 1, wherein the switching DC-to-DC power supply is at least a Buck, Boost, Flyback, Forward and Class D type.
